(19) United States
(12) Patent Application Publication
(10) Pub. No.: US 2026/0350879 A1
(43) Pub. Date: Nov. 5, 2026

(54) PRIVACY-AWARE IMAGE EDITING AND ENHANCEMENT PIPELINE

(71) Applicant: Purdue Research Foundation, West Lafayette, IN (US)

(72) Inventors: Dipesh Tamboli, Santa Clara, CA (US); Vineet Punyamoorty, West Lafayette, IN (US); Vaneet Aggarwal, West Lafayette, IN (US)

(73) Assignee: Purdue Research Foundation, West Lafayette, IN (US)

(21) Appl. No.: 19/440,442

(22) Filed: Jan. 5, 2026

Related U.S. Application Data
(60) Provisional application No. 63/799,484, filed on May 3, 2025.

(51) Int. Cl. G06T 11/60; G06T 3/40

(52) U.S. Cl. CPC G06T 11/60; G06T 3/40

(57) ABSTRACT

A method of securing sensitive information in an image when using an external editing system, includes obtaining an original image having one or more pieces of sensitive information defining a sensitive information region, communicating the original image to an information-identification system configured to detect the sensitive information region, receiving one or more sets of sensitive-information coordinates associated with a boundary of the sensitive information region along with a confidence score, applying one or more masks to the original image based on said boundary thereby generating a masked image, communicating the masked image to an external editing system configured to apply a user-selected editing to the masked image, thereby generating an edited masked image having an edited mask, receiving the edited masked image, and replacing the edited mask with image portions from the original image based on the one or more sets of sensitive-information coordinates.

### CROSS-REFERENCE TO RELATED APPLICATIONS

The present non-provisional patent application is related to and claims the priority benefit of U.S. Provisional Patent Application Ser. 63/799,484, filed May 3, 2025, the contents of which are hereby incorporated by reference in its entirety into the present disclosure.

### STATEMENT REGARDING GOVERNMENT FUNDING

None.

### TECHNICAL FIELD

The present disclosure generally relates to image editing systems and methods and in particular to a system and method that preserves privacy of sensitive information present in an image.

### BACKGROUND

This section introduces aspects that may help facilitate a better understanding of the disclosure. Accordingly, these statements are to be read in this light and are not to be understood as admissions about what is or is not prior art.

Image capture and editing by an external editing systems are nowadays a commonplace activity. Images may be sourced from cameras that capture still or live images (i.e., short videos), or from video recording devices generating long spans of videos each made up of a predetermined number of frames (i.e., images) per second. While consumers have access to systems that can edit such images, the external editing systems are typically more powerful and provide additional functionalities not found in personal devices. However, communicating images or videos to the external editing system is fraught with disclosing sensitive information that may not be suitable for such communication.

Therefore, there is an unmet need for a novel system and method that can automatically identify one or more pieces of sensitive information in an image, allow a user to automatically mask the one or more pieces of sensitive information prior to communicating the masked image to an external editing system, receive the edited masked image, and re-integrate the portions previously masked back into the edited image.

### SUMMARY

A method of securing sensitive information in an image when using an external editing system is disclosed. The method includes obtaining an original image having one or more pieces of sensitive information present therein, defining a sensitive information region, communicating the original image to an information-identification system configured to detect the sensitive information region based on detecting said one or more pieces of sensitive information, wherein the information-identification system applies a stochastic process, receiving one or more sets of sensitive-information coordinates associated with a boundary of the sensitive information region from the information-identification system along with a confidence score associated with said boundary of the sensitive information region, applying one or more masks to the original image based on said boundary of the sensitive information region, thereby obscuring said sensitive information region in the original image, thereby generating a masked image, communicating the masked image to an external editing system configured to apply a user-selected editing to the masked image, thereby generating an edited masked image including edited portions of the original image and edited portions of the one or more masks (edited mask), receiving the edited masked image from the external editing system, and replacing the edited mask with image portions from the original image based on the one or more sets of sensitive-information coordinates.

According to one embodiment of the method, the one or more pieces of sensitive information present in the image is selected from the group consisting of biometric identifiers, textual content, numbers, user-identifiable elements, and combinations thereof.

According to one embodiment of the method, the information-identification system comprises a neural-network-based landmark extractor configured to output boundary coordinates corresponding to said one or more pieces of sensitive information.

The method further includes using a predetermined confidence score threshold to determine if said one or more sets of sensitive-information coordinates is acceptable, and if not acceptable requesting said information-identification system to re-detecting said one or more pieces of sensitive information using said stochastic process.

According to one embodiment of the method, the predetermined confidence score threshold is a user-adjustable number.

According to one embodiment of the method, the user adjustable number is at least 70%.

According to one embodiment of the method, the edited mask is modified by coordinate translation based on said one or more sets of sensitive-information coordinates.

The method further includes adjusting privacy sensitivity based on a user-controlled privacy sensitivity adjustment, wherein the user-controlled privacy sensitivity adjustment provides manual or automated enlargement or reduction of the one or more masks.

According to one embodiment of the method, the one or more masks are selected from the group consisting of blurring, occlusion, substitution, and combinations thereof.

The method further includes determining a scaling factor based on ratios of dimensions associated with said edited masked image and dimensions of the original image, scaling the original image based on the scaling factor, and wherein the step replacing the edited mask with image portions from the original image is based on replacing the edited mask with image portions from the original image based on the scaled version of the original image.

A system for securing sensitive information in an image when using an external editing system is also disclosed. The system includes a processor executing software maintained on a non-transitory memory. The processor is configured to obtain an original image having one or more pieces of sensitive information present therein, defining a sensitive information region, apply the original image to an information-identification system configured to detect the sensitive information region based on detecting said one or more pieces of sensitive information, wherein the information-identification system applies a stochastic process, receive one or more sets of sensitive-information coordinates associated with a boundary of the sensitive information region from the information-identification system along with a confidence score associated with said boundary of the sensitive information region, apply one or more masks to the original image based on said boundary of the sensitive information region, to thereby obscure said sensitive information region in the original image, to thereby generate a masked image, communicate the masked image to an external editing system configured to apply a user-selected editing to the masked image, to thereby generate an edited masked image including edited portions of the original image and edited portions of the one or more masks (edited mask), receive the edited masked image from the external editing system, and replace the edited mask with image portions from the original image based on the one or more sets of sensitive-information coordinates.

According to one embodiment of the system, the one or more pieces of sensitive information present in the image is selected from the group consisting of biometric identifiers, textual content, numbers, user-identifiable elements, and combinations thereof.

According to one embodiment of the system, the information-identification system comprises a neural-network-based landmark extractor configured to output boundary coordinates corresponding to said one or more pieces of sensitive information.

According to one embodiment of the system, the processor is further configured to use a predetermined confidence score threshold to determine if said one or more sets of sensitive-information coordinates is acceptable, and if not acceptable request said information-identification system to re-detect said one or more pieces of sensitive information using said stochastic process.

According to one embodiment of the system, the predetermined confidence score threshold is a user-adjustable number.

According to one embodiment of the system, the user adjustable number is at least 70%.

According to one embodiment of the system, the edited mask is modified by coordinate translation based on said one or more sets of sensitive-information coordinates.

According to one embodiment of the system, the processor is further configured to adjust privacy sensitivity based on a user-controlled privacy sensitivity adjustment, wherein the user-controlled privacy sensitivity adjustment provides manual or automated enlargement or reduction of the one or more masks.

According to one embodiment of the system, the one or more masks are selected from the group consisting of blurring, occlusion, substitution, and combinations thereof.

According to one embodiment of the system, the processor is further configured to determine a scaling factor based on ratios of dimensions associated with said edited masked image and dimensions of the original image, scale the original image based on the scaling factor; and wherein the processor is configured to instead replace the edited mask with image portions from the original image based on the scaled version of the original image.

### BRIEF DESCRIPTION OF DRAWINGS

FIG. 1 is a block diagram depicting the method of the present disclosure.

FIG. 2 is a high-level block diagram of a processing system, according to the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 15%, within 10%, within 5%, or within 1% of a stated value or of a stated limit of a range.

In the present disclosure, the term “substantially” can allow for a degree of variability in a value or range, for example, within 85%, within 90%, within 95%, or within 99% of a stated value or of a stated limit of a range.

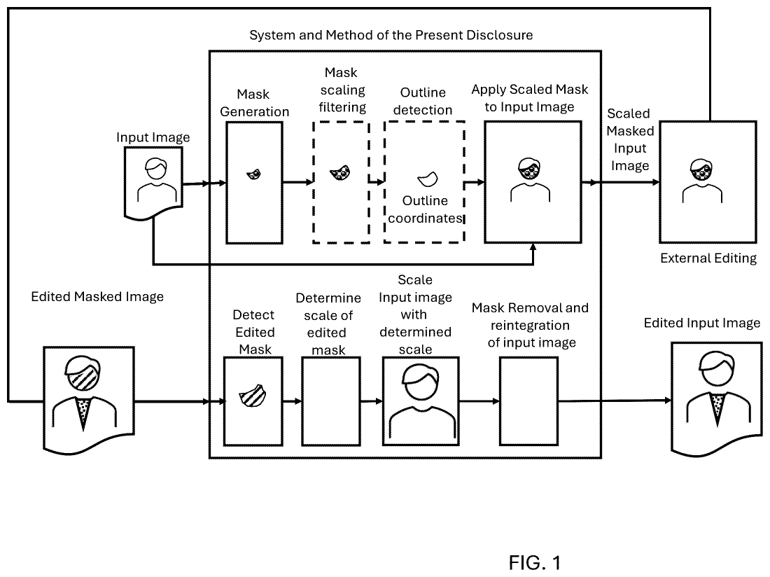

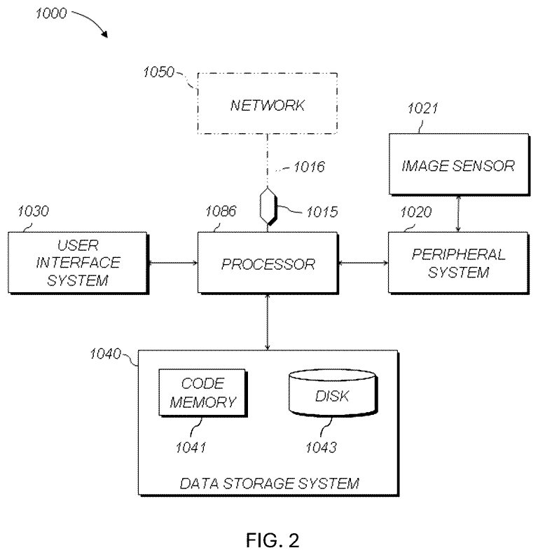

A novel system and method are disclosed herein that can automatically identify one or more pieces of sensitive information in an image, allow a user to automatically mask the one or more pieces of sensitive information prior to communicating the masked image to an external editing system, receive the edited masked image, and re-integrate the portions previously masked back into the edited image. Towards this end, reference is made to FIG. 1 which is a high-level system diagram depicting various components of the system. The system includes a processor which is configured to execute software housed in a non-transient memory. The processor and supporting components are shown in FIG. 2, which is a high-level block diagram of the processing system, according to the present disclosure. When the software is executed, the processor is configured to obtain an image previously captured by an image capture device, e.g., a still or live image camera or a video camera capable of capturing videos containing a predetermined number of frames (i.e., images) per second. The image may be a high-definition image containing millions of pixels, each having data associated with one or more channels, e.g., red-green-blue channels. The image may contain one or more pieces of sensitive information present therein. Example of sensitive information may include biometric identifiers (e.g., facial identifiers of a person), textual content (e.g., a license plate), numbers, user-identifiable elements (i.e., specific classes of items of interest provided by a user), or combinations thereof. In FIG. 1, the image is identified as the input image.

At a high level, the image is received by the processor of the present disclosure, as shown in FIG. 1. The processor initially receives the input image and identifies sensitive areas in the image to be protected. A mask is thus generated based on this identification. The mask may be optionally scaled by a user to further cover the sensitive areas. Once the mask is completed, the (scaled) mask is applied to the input image. The (scaled) masked input image is then communicated to an external editing software that applied editing. For example, as shown in FIG. 1, the input image may be a headshot of an individual in a T-shirt. Formulaically, suppose the input image (Iᵢₙ) has a width Wᵢₙ and height Hᵢₙ. The Mask is Mᵢ. Thus, the sensitive area (Rᵢₙ) can be expressed as Rᵢₙ=Iᵢₙ ⊙Mᵢ. If the mask is optionally scaled by Sᵢₙ, then the input mask has the form:

$${M}_{in}^{′} = {S}_{in} \cdot {M}_{in} .$$

The external editing software edits the (scaled) masked input image and communicates the edited (scaled) masked input image back to the processor. The editing may be to transform the headshot to incorporate a suit instead of the T-shirt in the image. The edited (scaled) masked image is then received by the processor. The edited (scaled) masked image may be scaled by the external editing software. For example, suppose the edited image has a width W_{edit} and a height H_{edit}. The scaling by the external editing software is then obtained by:

$${s}_{x} = \frac{{W}_{edit}}{{W}_{in}} , {s}_{y} = \frac{{H}_{edit}}{{H}_{in}} . \qquad ( 1 )$$

For example, suppose the edited image is twice as large as the (scaled) masked input image, then sₓ and s_{y} each would be 2.0. Therefore, the edited mask

$$( {M}_{edit}^{′} )$$

is expressed as:

$${M}_{edit}^{′} = scale ( {M}_{in}^{′} , {s}_{x} , {s}_{y} ) . \qquad ( 2 )$$

The processor then initially detects the edited (scaled) mask

$$( {M}_{edit}^{′} ) .$$

Additionally, the edited image may have had its mask translated from its original relative position in the (scaled) masked input image. As needed, the detected edited (scaled) mask may be translated to the same relative position as the (scaled) masked in the input image provided to the external editing software. Once translated, the scaling resulting from the editing is determined by the processor based on equation (2), above. The processor then scales the input image by the determined scale from the editing process. This operation requires interpolation. Therefore, the input image is scaled up/down by sₓ and s_{y} using interpolation, as is known to a person having ordinary skill in the art. The scaled input image yields a scaled sensitive area as expressed by:

R_{scaled}=Resize(R_{in′}Wᵢₙ·s_{x″}Hᵢₙ·s_{y}). (3)

The processor then reintegrates pixel information for the R_{scaled} into the edited (scaled) input image to thereby reconstitute the input image but in the edited modality. Once reintegrated, the edited image may be scaled again to achieve the same size as the original input image (Iᵢₙ).

To achieve the steps outlined above, the processor establishes a coordinate system, e.g., a Cartesian Coordinate system, assigning a point in the image, e.g., the upper left corner, as the origin of the coordinate system. As discussed above, the input image is communicated to an information-identification system (e.g., a neural network-based tool that is configured to detect the one or more pieces of sensitive information present in the image. While not shown, the information-identification system may be configured to receive input from the user of the classes of items of interest to be classified as sensitive information. Therefore, the information-identification system (identified as the mask generation block) receives the input image with the pre-assigned coordinate system and optionally input from the user (not shown) identifying specific classes of items to be tagged by the information-identification system as sensitive information. The output of the information-identification system includes coordinates of detected one or more pieces of sensitive information, e.g., coordinates of a mask containing the sensitive information. Additionally, for each detected sensitive information the information-identification system also outputs a confidence level between 1% (indicating very low level of confidence) to 100% (highest level of confidence). The confidence level can be used to avoid false positives by applying a filter, as discussed below. In general, the output of the information-identification system includes sets of coordinates of the one or more pieces of sensitive information.

The processor generates the one or more sets of sensitive-information coordinates from the information-identification system associated with one or more detected sensitive information in the image along with the associated confidence level score associated with each set of sensitive-information coordinates. The processor then filters the one or more sets of sensitive-information coordinates defining the mask based on a predetermined confidence score threshold, thus generating one or more sets of filtered sensitive-information coordinates. If the confidence level associated with a set of sensitive-information coordinates is below the predetermined threshold, the processor discards information associated with that detected sensitive information. According to one embodiment, the predetermined threshold is about 70%, i.e., any set of sensitive-information coordinates with a confidence level below 70% is discarded; or based on a user defined or dynamic learning process. The aforementioned process is repeated for each set of sensitive-information coordinates until all such sensitive information have been accounted for.

The masking operation can be applied directly to the image based on the one or more sets of filtered sensitive-information coordinates, thereby obscuring the one or more detected sensitive information in the image, thereby generating a masked image. Alternatively, in order to refine the mask region, the system may invoke an outline detection module that returns fine-grained boundaries (e.g., contours, facial landmarks) derived from the filtered coordinates. These refined boundaries are then used to construct accurate masks. Specifically, the one or more sets of filtered sensitive-information coordinates are provided to an outline detection system (e.g., a second neural network-based tool) first in order to ascertain a fine-tuned set of coordinates (referred to in FIG. 1 as the outline coordinates) associated with each detected and filtered sensitive information. Once the fine-tuned set of coordinates are provided by the outline detection system, masks are provided only to those coordinates, thus resulting in a fine-tuned masking operation. In either case, a masked image is generated by the processor (that is one of i) a masked input image, ii) a scaled masked input image, iii) an outline-detected mask, or iv) a scaled-outlined detected mask).

When the processor communicates the masked image to the external editing system, that external system is configured to apply a user-selected editing to the masked image, thereby generating an edited masked image. The edited masked image may also include edits of the mask areas of the masked image. Next, the processor receives the edited masked image from the external editing system generating an edited image potentially including even one or more edited masks.

The masking operation discussed herein may include one or more masks that are selected from the group consisting of blurring, occlusion, substitution, and combinations thereof. The mask generation process, and the mask generation block of FIG. 1 are further discussed below.

The mask generation block in FIG. 1 represents a machine learning approach, e.g., a neural network. In case of the neural network, the network is first trained. To construct the training set, a subset of publicly available images where the subject is facing the camera were chosen. The algorithm below was used to provide a pipeline for mask generation and beyond.

Algorithm 1

| Require: | |
|---|---|
| img_id: Unique image identifier | |
| edit_task: Text prompt (e.g., ”studio headshot”) | |
| Ensure: | |
| Identity-restored edited output and CLIP alignment scores | |
| 1: | procedure RUNPIPELINE(img_id, edit_task) |
| 2: | inp ←″input_og_imgs/″ +img_id+ ″.jpg″ |
| 3: | mask ← ″masked_imgs/″ +img_id+ ″ _mask.jpg″ |
| 4: | gen_private ←″gpt_generated/″ +img_id+ |
| ″ private.jpg″ | |
| 5: | gen recon ← ″gpt_generated/″ + img_id + ″_recon.jpg″ |
| 6: | final ← ″ours_edited/″ + img_id + ″_final.jpg″ |
| 7: | // Face occlusion |
| 8: | MASKIMAGE(inp, mask) |
| 9: | // Reconstruction via masked input |
| 10: | CALLTHIRDPARTYAPI(mask, gen_recon, edit task) |
| 11: | // External editing |
| 12: | CALLTHIRDPARTYAPI(mask, gen_private, edit task) |
| 13: | // Identity reinjection |
| 14: | SWAPFACEBACK(inp, gen_private, final) |
| 15: | // CLIP-based evaluation |
| 16: | s_{orig} ← COMPUTECLIPSCORE(inp, edit_task) |
| 17: | s_{gpt} ← COMPUTECLIPSCORE(gen_private, edit_task) |
| 18: | sₒᵤᵣₛ ← COMPUTECLIPSCORE(final, edit_task ) |
| 19: | return {s_{orig}, s_{gpt}, sₒᵤᵣₛ} |
| 20: | end procedure |

The pipeline described by the above algorithm begins with local face occlusion (lines 6-7), where facial landmarks are detected and masked using convex-hull generation and edge blending, as known to a person having ordinary skill in the art. An optional reconstruction vulnerability check (line 9) uses the masked input to assess its resilience to a third-party recovery. The core editing step (line 11) invokes the generative API using the masked image and the user prompt. After receiving the edited output, identity reinjection (line 14) is performed by aligning and blending the original unmasked face into the generated image. CLIP-based alignment evaluation (lines 17-19) then scores the original, external editing system software, and final outputs with respect to the prompt. Optionally, a composite visualization (line 21) is generated to summarize the pipeline output for inspection or presentation.

Accurate facial-landmark detection is critical to preserve privacy. According to one embodiment, about 468 3D points are located on the user's face. From these landmarks, a tight convex-hull is constructed around the identity-sensitive region (cheeks, nose, eyes, mouth, etc.). To ensure robustness, the hull is scaled by a small factor (controlled internally but not exposed to the end user) to cover any residual identity cues. A Canny-edge overlay is blended smoothly onto this hull to create a soft occlusion, guaranteeing that downstream generative models never receive an unprotected face. This entire procedure is implemented in a single call:
MASKIMAGE(inpPath, maskPath). The resulting maskPath image retains all non-facial content (hair, background, clothing, etc.) while fully concealing biometric features.

Once privacy is guaranteed, the user's desired generative edit is requested on the masked image:
CALLTHIRDPARTYAPI(maskPath, gptPrivatePath, task).

Because only the non-sensitive pixel data remains, the external editing system service can safely perform any transformation (e.g., style transfer, headshot generation, color correction) without ever seeing the user's true identity. The API returns a masked but edited image, stored at gptPrivatePath.

To produce a final, photorealistic output that fulfills the user's request and restores the original identity, PRIVATEEDIT executes:
SWAPFACEBACK(inpPath, gptPrivatePath, outputPath).

As discussed above, the edited image is analyzed to locate landmarks. The original, unmasked face region (from inpPath) is geometrically aligned (via a piecewise affine warp (known to a person having ordinary skill in the art)) to the edited face's new pose and lighting. Finally, a structure-preserving Poisson-blending operator (known to a person having ordinary skill in the art) seamlessly merges the original facial pixels into the edited context. The result (outputPath) is a full-resolution image that satisfies the editing prompt while preserving true identity.

To quantitatively validate that PRIVATEEDIT's final fused output still aligns with the user's intended “task,” the method of the present disclosure computes three CLIP scores:
s_{orig}←COMPUTECLIPSCORE(inpPath, task),
sₒᵤᵣₛ←COMPUTECLIPSCORE(outputPath, task), and
s_{gpt}←COMPUTECLIPSCORE(gptPrivatePath, task).

A semantic similarity is used between the image and the text prompt. A higher score indicates closer adherence to the user's specification. Reporting (s_{orig}, s_{gpt}, sₒᵤᵣₛ) allows direct comparison between (a) the unedited original, (b) the external party masked baseline edit, and (c) the process' final identity-restored result. In practice, sₒᵤᵣₛ remains on-par with or exceeds s_{gpt}, indicating that re-injecting identity does not degrade semantic fidelity.

The system described herein allows for adjustment of privacy sensitivity based on a user-controlled privacy sensitivity adjustment. The user-controlled privacy sensitivity adjustment provides manual or automated expansion or contraction of the one or more masks about the filtered sensitive-information coordinates or the outline coordinates, depending on which strategy is used by the processor, as discussed above.

Furthermore, referring back to FIG. 1, the processor may use a different mask based on the sensitive information detected by the information-identification system. According to one embodiment, the information-identification system may in addition to the output coordinates and confidence level, also provide an output (not shown) that classifies the sensitivity of information. Based on this output (not shown), the processor may apply various types of masks. The mask selection may be automatically based on a look-up table or based on user input selectivity (not shown). The look-up table may associate mask types (e.g., blur, occlude) with classes of sensitive information (e.g., blur type is used for faces, occlusion is used for license plates, etc.).

It should be appreciated that as discussed above, the system and method of the present disclosure obtain an original image having one or more pieces of sensitive information present therein, the one or more pieces of sensitive information thus defining a sensitive information region. The system and method of the present disclosure are further configured to communicate the original image to an information-identification system (as part of or external to the system and method described herein) that is in turn configured to detect the sensitive information region based on detecting said one or more pieces of sensitive information. The information-identification system applies a stochastic process to the detection of the one or more pieces of sensitive information. The system and method of the present disclosure are further configured to receive one or more sets of sensitive-information coordinates associated with a boundary of the sensitive information region from the information-identification system along with a confidence score associated with said boundary of the sensitive information region. Furthermore, the system and method of the present disclosure are configured to apply one or more masks to the original image based on said received boundary of the sensitive information region, thereby obscuring said sensitive information region in the original image, thereby generating a masked image. Additionally, the system and method of the present disclosure are configured to communicate the masked image to an external editing system that in is in turn configured to apply a user-selected editing to the masked image, thereby generating an edited masked image including edited portions of the original image and edited portions of the one or more masks (edited mask). The system and method of the present disclosure are further configured to receive the edited masked image from the external editing system. The edited masked image may have been scaled, cropped, or positionally translated based on the original image. The system and method of the present disclosure are then further configured to replace the edited mask with image portions from the original image based on the one or more sets of sensitive-information coordinates. If the system and method of the present disclosure determine the external editing system has scaled, cropped, or positionally translated (any one or more of these editing artifacts) the edited masked image based on the original image, then as discussed above, the system and method of the present disclosure rescale the edited masked image, re-insert the cropped portion, or positionally re-translate based on the original image. It should also be appreciated that guarding against disclosure and unwanted alterations of sensitive information in an image when the image is being edited by an external editing system represents a practical application. The system and method disclosed herein provide an improvement for a solution in existing technology related to this practical application.

Referring to FIG. 2, an example of a processing system is provided that can carry out the above processes. Referring to FIG. 2, a high-level diagram showing the components of an exemplary data-processing system 1000 for analyzing data and performing other analyses described herein, and related components. The system includes a processor 1086, a peripheral system 1020, a user interface system 1030, and a data storage system 1040. The peripheral system 1020, the user interface system 1030 and the data storage system 1040 are communicatively connected to the processor 1086. Processor 1086 can be communicatively connected to network 1050 (shown in phantom), e.g., the Internet or a leased line, as discussed below. The imaging described in the present disclosure may be obtained using imaging sensors 1021 and/or displayed using display units (included in user interface system 1030) which can each include one or more of systems 1086, 1020, 1030, 1040, and can each connect to one or more network(s) 1050. Processor 1086, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 1086 can implement processes of various aspects described herein. Processor 1086 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. Processor 1086 can include Harvard-architecture components, modified-Harvard-architecture components, or Von-Neumann-architecture components.

The phrase “communicatively connected” includes any type of connection, wired or wireless, for communicating data between devices or processors. These devices or processors can be located in physical proximity or not. For example, subsystems such as peripheral system 1020, user interface system 1030, and data storage system 1040 are shown separately from the data processing system 1086 but can be stored completely or partially within the data processing system 1086.

The peripheral system 1020 can include one or more devices configured to provide digital content records to the processor 1086. For example, the peripheral system 1020 can include digital still cameras, digital video cameras, cellular phones, or other data processors. The processor 1086, upon receipt of digital content records from a device in the peripheral system 1020, can store such digital content records in the data storage system 1040.

The user interface system 1030 can include a mouse, a keyboard, another computer (connected, e.g., via a network or a null-modem cable), or any device or combination of devices from which data is input to the processor 1086. The user interface system 1030 also can include a display device, a processor-accessible memory, or any device or combination of devices to which data is output by the processor 1086. The user interface system 1030 and the data storage system 1040 can share a processor-accessible memory.

In various aspects, processor 1086 includes or is connected to communication interface 1015 that is coupled via network link 1016 (shown in phantom) to network 1050. For example, communication interface 1015 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 1015 sends and receives electrical, electromagnetic or optical signals that carry digital or analog data streams representing various types of information across network link 1016 to network 1050. Network link 1016 can be connected to network 1050 via a switch, gateway, hub, router, or other networking device.

Processor 1086 can send messages and receive data, including program code, through network 1050, network link 1016 and communication interface 1015. For example, a server can store requested code for an application program (e.g., a JAVA applet) on a tangible non-volatile computer-readable storage medium to which it is connected. The server can retrieve the code from the medium and transmit it through network 1050 to communication interface 1015. The received code can be executed by processor 1086 as it is received or stored in data storage system 1040 for later execution.

Data storage system 1040 can include or be communicatively connected with one or more processor-accessible memories configured to store information. The memories can be, e.g., within a chassis or as parts of a distributed system. The phrase “processor-accessible memory” is intended to include any data storage device to or from which processor 1086 can transfer data (using appropriate components of peripheral system 1020), whether volatile or nonvolatile; removable or fixed; electronic, magnetic, optical, chemical, mechanical, or otherwise. Exemplary processor-accessible memories include but are not limited to registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 1040 can be a tangible non-transitory computer-readable storage medium, i.e., a non-transitory device or article of manufacture that participates in storing instructions that can be provided to processor 1086 for execution.

In an example, data storage system 1040 includes code memory 1041, e.g., a RAM, and disk 1043, e.g., a tangible computer-readable rotational storage device such as a hard drive. Computer program instructions are read into code memory 1041 from disk 1043. Processor 1086 then executes one or more sequences of the computer program instructions loaded into code memory 1041, as a result performing process steps described herein. In this way, processor 1086 carries out a computer implemented process. For example, steps of methods described herein, blocks of the flowchart illustrations or block diagrams herein, and combinations of those, can be implemented by computer program instructions. Code memory 1041 can also store data or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects. These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 1086 (and possibly also other processors), to cause functions, acts, or operational steps of various aspects herein to be performed by the processor 1086 (or other processors). Computer program code for carrying out operations for various aspects described herein may be written in any combination of one or more programming language(s) and can be loaded from disk 1043 into code memory 1041 for execution. The program code may execute, e.g., entirely on processor 1086, partly on processor 1086 and partly on a remote computer connected to network 1050, or entirely on the remote computer.

Those having ordinary skill in the art will recognize that numerous modifications can be made to the specific implementations described above. The implementations should not be limited to the particular limitations described. Other implementations may be possible.

1. A method of securing sensitive information in an image when using an external editing system, comprising:
obtaining an original image having one or more pieces of sensitive information present therein, defining a sensitive information region;
communicating the original image to an information-identification system configured to detect the sensitive information region based on detecting said one or more pieces of sensitive information, wherein the information-identification system applies a stochastic process;
receiving one or more sets of sensitive-information coordinates associated with a boundary of the sensitive information region from the information-identification system along with a confidence score associated with said boundary of the sensitive information region;
applying one or more masks to the original image based on said boundary of the sensitive information region, thereby obscuring said sensitive information region in the original image, thereby generating a masked image;
communicating the masked image to an external editing system configured to apply a user-selected editing to the masked image, thereby generating an edited masked image including edited portions of the original image and edited portions of the one or more masks (edited mask);
receiving the edited masked image from the external editing system; and
replacing the edited mask with image portions from the original image based on the one or more sets of sensitive-information coordinates.

2. The method of claim 1, wherein the one or more pieces of sensitive information present in the image is selected from the group consisting of biometric identifiers, textual content, numbers, user-identifiable elements, and combinations thereof.

3. The method of claim 1, wherein the information-identification system comprises a neural-network-based landmark extractor configured to output boundary coordinates corresponding to said one or more pieces of sensitive information.

4. The method of claim 1, further comprising using a predetermined confidence score threshold to determine if said one or more sets of sensitive-information coordinates is acceptable, and if not acceptable requesting said information-identification system to re-detecting said one or more pieces of sensitive information using said stochastic process.

5. The method of claim 4, wherein the predetermined confidence score threshold is a user-adjustable number.

6. The method of claim 5, wherein the user adjustable number is at least 70%.

7. The method of claim 1, wherein the edited mask is modified by coordinate translation based on said one or more sets of sensitive-information coordinates.

8. The method of claim 1, further comprising:
adjusting privacy sensitivity based on a user-controlled privacy sensitivity adjustment, wherein the user-controlled privacy sensitivity adjustment provides manual or automated enlargement or reduction of the one or more masks.

9. The method of claim 1, wherein the one or more masks are selected from the group consisting of blurring, occlusion, substitution, and combinations thereof.

10. The method of claim 1, further comprising:
determining a scaling factor based on ratios of dimensions associated with said edited masked image and dimensions of the original image;
scaling the original image based on the scaling factor; and
wherein the step of replacing the edited mask with image portions from the original image is based on replacing the edited mask with image portions from the original image based on the scaled version of the original image.

11. A system for securing sensitive information in an image when using an external editing system, comprising:
a processor executing software maintained on a non-transitory memory, the processor configured to:
obtain an original image having one or more pieces of sensitive information present therein, defining a sensitive information region;
apply the original image to an information-identification system configured to detect the sensitive information region based on detecting said one or more pieces of sensitive information, wherein the information-identification system applies a stochastic process;
receive one or more sets of sensitive-information coordinates associated with a boundary of the sensitive information region from the information-identification system along with a confidence score associated with said boundary of the sensitive information region;
apply one or more masks to the original image based on said boundary of the sensitive information region, to thereby obscure said sensitive information region in the original image, to thereby generate a masked image;
communicate the masked image to an external editing system configured to apply a user-selected editing to the masked image, to thereby generate an edited masked image including edited portions of the original image and edited portions of the one or more masks (edited mask);
receive the edited masked image from the external editing system; and
replace the edited mask with image portions from the original image based on the one or more sets of sensitive-information coordinates.

12. The system of claim 11, wherein the one or more pieces of sensitive information present in the image is selected from the group consisting of biometric identifiers, textual content, numbers, user-identifiable elements, and combinations thereof.

13. The system of claim 11, wherein the information-identification system comprises a neural-network-based landmark extractor configured to output boundary coordinates corresponding to said one or more pieces of sensitive information.

14. The system of claim 11, the processor is further configured to use a predetermined confidence score threshold to determine if said one or more sets of sensitive-information coordinates is acceptable, and if not acceptable request said information-identification system to re-detect said one or more pieces of sensitive information using said stochastic process.

15. The system of claim 14, wherein the predetermined confidence score threshold is a user-adjustable number.

16. The system of claim 15, wherein the user adjustable number is at least 70%.

17. The system of claim 11, wherein the edited mask is modified by coordinate translation based on said one or more sets of sensitive-information coordinates.

18. The system of claim 11, the processor is further configured to adjust privacy sensitivity based on a user-controlled privacy sensitivity adjustment, wherein the user-controlled privacy sensitivity adjustment provides manual or automated enlargement or reduction of the one or more masks.

19. The system of claim 11, wherein the one or more masks are selected from the group consisting of blurring, occlusion, substitution, and combinations thereof.

20. The system of claim 11, the processor is further configured to:
determine a scaling factor based on ratios of dimensions associated with said edited masked image and dimensions of the original image;
scale the original image based on the scaling factor; and
wherein the processor is configured to replace the edited mask with image portions from the original image based on the scaled version of the original image.
